(19) United States
(12) Patent Application Publication
(10) Pub. No.: US 2008/0066469 A1
(43) Pub. Date: Mar. 20, 2008

(54) SYSTEM AND METHOD FOR GENERATING ELECTRICAL ENERGY UTILIZING RECAPTURED CARBON DIOXIDE

(76) Inventor: Paul L. Scherzer, Midland, TX (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/856,471

(22) Filed: Sep. 17, 2007

Related U.S. Application Data
(60) Provisional application No. 60/844,883, filed on Sep. 15, 2006.

(51) Int. Cl. F02C 1/00; F03B 13/00

(52) U.S. Cl. 60/772; 290/54; 60/39.01

(57) ABSTRACT

A system for generating power in the form of electrical energy utilizing recaptured carbon dioxide includes a compressor connected to a recapturing system of a power plant or factory through a transporting pipeline. The compressor provides an increase in the flow pressure of the recaptured carbon dioxide such that the flow pressure is sufficient to turn the blades of a turbine coupled to the compressor. The turbine turns a shaft of an electrical energy generator, which generates electrical energy. Generated electrical energy is delivered to consumers. A sequestering site included in the system accomplishes enhanced recovery procedures.

### CROSS-REFERENCE TO RELATED APPLICATION

This Application claims the benefit of priority of U.S. Provisional Patent Application Ser. No. 60/844,883, filed Sep. 15, 2006.

### BACKGROUND

The present invention relates generally to the field of generating power in the form of electrical energy. More particularly, this invention is directed to generating power in the form of electrical energy using a by-product, such as carbon dioxide. The invention relates also to environmental remediation systems and methods.

The most prevalent form of electrical energy generation at this time in the United States is from fossil fuel systems. These systems include mainly coal and natural gas fired systems, as well as nuclear systems which account for about 15% of the market. While some progress is being achieved in making these systems more environmentally safe, they nonetheless produce large quantities of pollutants and toxic chemicals, among which carbon dioxide is one of the most offensive and dangerous, its proportion in the atmosphere increasing yearly. Mechanisms to reduce the amount of these by-products are expensive to build and take large amounts of energy from the plant to operate. The energy consumed in reducing these by-products decreases the net electrical energy output of the generation plant, and thereby lowers the efficiency of a conventional plant into a range of 34 to 42%.

### SUMMARY OF INVENTION

In accordance with the present invention, there is provided an environmental remediation system and method that utilizes by-products produced by conventional power plants.

Further, in accordance with the present invention, there is provided a system and method for generating power in the form of electrical energy utilizing a by-product.

Still further, in accordance with the present invention, there is provided an environmental remediation system that includes means adapted for recapturing carbon dioxide from a by-product of a power producing means. The system also includes sequestering means and means for transporting the flow of the recaptured carbon dioxide to the sequestering means, or to a producing hydrocarbon reservoir for accomplishing enhanced recovery procedures.

Still further, in accordance with the present invention, there is provided a system for generating power in the form of electrical energy utilizing recaptured carbon dioxide. The system includes recapturing means adapted for recapturing carbon dioxide from a by-product of power generating means and producing a flow of recaptured carbon dioxide. The system further includes first transporting means coupled with the recapturing means, and turbine means coupled with the first transporting means. The first transporting means is adapted for transporting the flow of the recaptured carbon dioxide. The turbine means is adapted for receiving, via the first transporting means, the flow of the recaptured carbon dioxide. The turbine means is further adapted for running under an impact of the flow of the recaptured carbon dioxide. Also included in the system is electrical energy generating means coupled with the turbine means. The turbine means is further adapted for actuating the electrical energy generating means. The electrical energy generating means is adapted for generating electrical energy under actuation of the turbine means.

Still further, in accordance with one embodiment of the subject application, there is provided a method for generating power in the form of electrical energy in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawing and description will be regarded as illustrative in nature and not as restrictive.

### BRIEF DESCRIPTION OF THE DRAWING

The accompanying drawings incorporated in and forming a part of the specification, illustrate several aspects of the subject application, and together with the description serve to explain the principles of the subject application. In the drawings:

FIG. 1 is a schematic diagram of a system for generating electrical energy in accordance with one embodiment of the subject application; and

FIG. 2 is a flowchart illustrating a method for generating electrical energy in accordance with one embodiment of the subject application.

### DETAILED DESCRIPTION OF THE INVENTION

The subject application is directed to generating power in the form of electrical energy utilizing a by-product, such as carbon dioxide. The subject application is further directed to environmental remediation systems and methods.

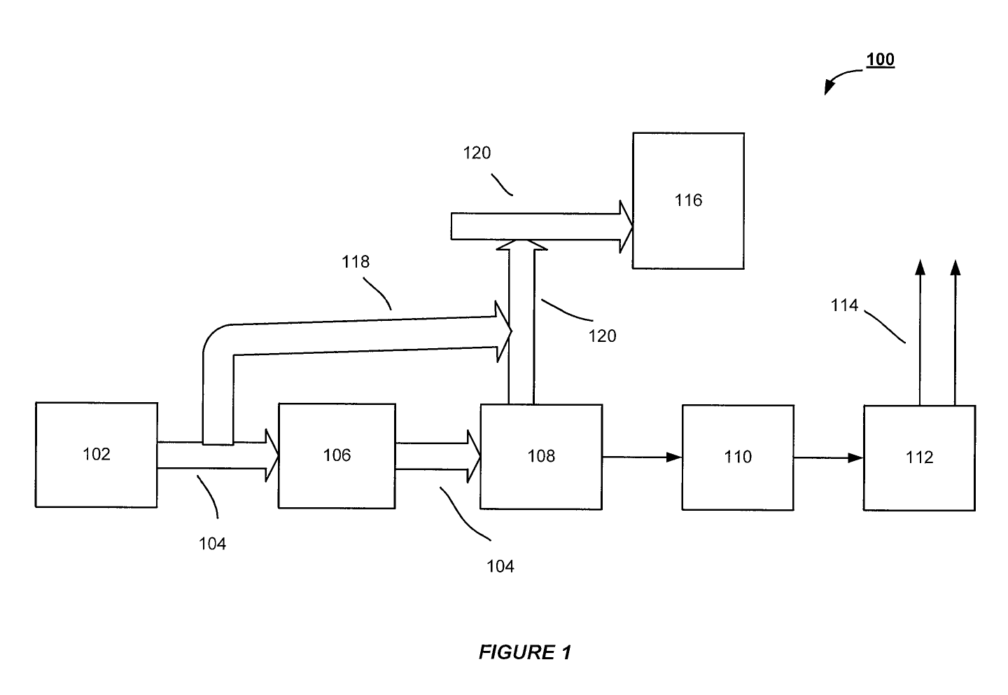

Referring now to FIG. 1, there is shown an overall diagram of a system 100 for generating electrical energy in accordance with one embodiment of the subject application. As shown in FIG. 1, the system 100 includes a recapturing arrangement 102 that provides recapturing carbon dioxide from a by-product of a power generating means, such as a power plant or a factory (not shown in the drawing). As will be recognized by those skilled in the art, the recapturing arrangement 102 is capable of any implementation known in the art. As will be further appreciated by a skilled artisan, the recapturing arrangement 102 produces a flow of recaptured carbon dioxide. The system 100, as depicted in FIG. 1, also includes a first transporting arrangement 104 coupled with the recapturing arrangement 102 and with a compression apparatus 106. As will be appreciated by a skilled artisan, the first transporting arrangement 104 advantageously incorporates suitable cutoff valves, safety valves and chokes known in the art. A skilled artisan will also understand that the compression apparatus 106 is capable of implementation as any compressor known in the art, suitable for converting the flow of recaptured carbon dioxide of a lower pressure to a flow of recaptured carbon dioxide of a higher pressure such that the pressure is sufficient to run a turbine 108 included in the system 100, as will be described in detail below.

Those skilled in the art will recognize that the compression apparatus 106 is not necessarily included in the system 100. When the flow of recaptured carbon dioxide is of a sufficient pressure to run the turbine 108, the compression apparatus 106 is not included in the system 100, and the turbine 108 is directly coupled with the recapturing arrangement 102 via the first transporting arrangement 104. The system of FIG. 1 further includes an electrical energy generator 110, wherein a shaft of the electrical energy generator 110 is coupled with the turbine 108. As will be appreciated by a skilled artisan, the turbine 108 is capable of being implemented, for example and without limitation, as a gas turbine that extracts energy from a flow of gas, as known in the art. Simple turbines might have one moving part, wherein more sophisticated turbines may have multiple shafts, hundreds of turbine blades, movable stator blades, and a vast system of complex piping, combustors and heat exchangers.

As a general rule, the smaller the engine is the higher rotation rate of the shaft is necessary to maintain given blade tip speed. Turbine blade tip speed determines the maximum pressure that can be gained, independent of the size of the engine. The electrical energy generator 110 is capable of being implemented as any device known in the art that converts kinetic energy into electrical energy. A distribution transformer 112 is coupled with the electrical energy generator 110 for converting the generated electrical energy of a higher voltage to electrical energy of a lower voltage. A transmission arrangement 114 is coupled with the distribution transformer 112 to provide for supplying of the electrical energy of a lower voltage to associated users.

In the embodiment depicted in FIG. 1, the system 100 further includes a sequestering site 116. In one embodiment, the sequestering site 116 is advantageously implemented as a suitable hydrocarbon producing reservoir known in the art. As will be appreciated by a skilled artisan, the sequestering site 116 advantageously accomplishes enhanced recovery procedures. In an alternative embodiment the sequestering site 116 is a suitable sequestration site for carbon dioxide. The sequestering site 116 is coupled with the turbine 108 via a second transporting arrangement 120. In one embodiment, the system 100 further includes a bypass pipeline 118 that is used for necessary maintenance. In this embodiment, the recapturing arrangement 102 is coupled with the sequestering site 116 via the bypass pipeline 118 and the second transporting arrangement 120. A skilled artisan will appreciate that the bypass pipeline 118 and the second transporting arrangement 120 are capable of being implemented analogous to the first transporting arrangement 104, as known in the art.

In operation, carbon dioxide is first recaptured from a by-product of power generating means. A flow of recaptured carbon dioxide is then produced and directed to a turbine. The flow of the recaptured carbon dioxide is then received by the turbine. Under an impact of the flow of the recaptured carbon dioxide received by the turbine, the turbine is run. Next, electrical energy is generated under actuation of the turbine.

In accordance with one example embodiment of the subject application, carbon dioxide is first recaptured by a recapturing arrangement 102 from a by-product of power generating means, such as a power plant or a factory (not shown in the drawing). The recapturing arrangement 102 produces a flow of recaptured carbon dioxide. The flow of recaptured carbon dioxide via a first transporting arrangement 104 is transported to the compression apparatus 106. The compression apparatus 106 converts the flow of recaptured carbon dioxide of a lower pressure to a flow of recaptured carbon dioxide of a higher pressure such that the pressure is sufficient to run the turbine 108.

The turbine 108 runs under an impact of the flow of the recaptured carbon dioxide delivered via the first transporting arrangement 104. That is the flow of the recaptured carbon dioxide delivered via the first transporting arrangement 104 suitably turns the blades of the turbine 108, as will be understood by those skilled in the art. Energy is extracted from the turbine 108 in the form of shaft power. As described above, the shaft of the electrical energy generator 110 is coupled with the turbine 108. Thus, the turbine 108 actuates the electrical energy generator 110 enabling the electrical energy generator 110 to produce electrical energy. Once electrical energy is produced by the electrical energy generator 110, it is further routed to the distribution transformer 112. The distribution transformer 112 suitably converts the generated electrical energy of a higher voltage to electrical energy of a lower voltage for sending to associated consumers in a known manner over the transmission arrangement 114 suitably incorporated into the system 100 of the invention. As will be appreciated by those skilled in the art, the voltage of the electrical energy generated by the electrical energy generator 110 is typically in the range of 1,000 volts to 100,000 volts. The premises of associated users typically use a voltage between 100 volts and 240 volts, depending on the system. In the United States, this voltage is typically about 120 volts. Thus, the distribution transformer 112 provides conversion of the high voltage electrical energy generated by the electrical energy generator 110 to low voltage electrical energy, which is supplied to associated users via the transmission arrangement 114.

In an alternative embodiment, as will be recognized by a skilled artisan, in the event that the flow pressure of the recaptured carbon dioxide is sufficient to run the turbine 108, the flow of the recaptured carbon dioxide is transmitted directly to the turbine 108 bypassing the compressing means (bypassing not shown in the drawing) via the first transporting arrangement 104. In one embodiment, the flow of the recaptured carbon dioxide after being released from the turbine 108 is transported via the second transporting arrangement 120 to the sequestering site 116 for accomplishing enhanced recovery procedures. In an alternate embodiment, the flow of the recaptured carbon dioxide is capable of being transmitted directly to the sequestering site 116 via the bypass pipeline 118 and the second transporting arrangement 120.

A skilled artisan will appreciate, that the system 100 for generating electrical energy is suitable to be installed at a power plant or factory, at a sequestration site, at a producing hydrocarbon reservoir, or at a suitable point along transporting arrangement 120.

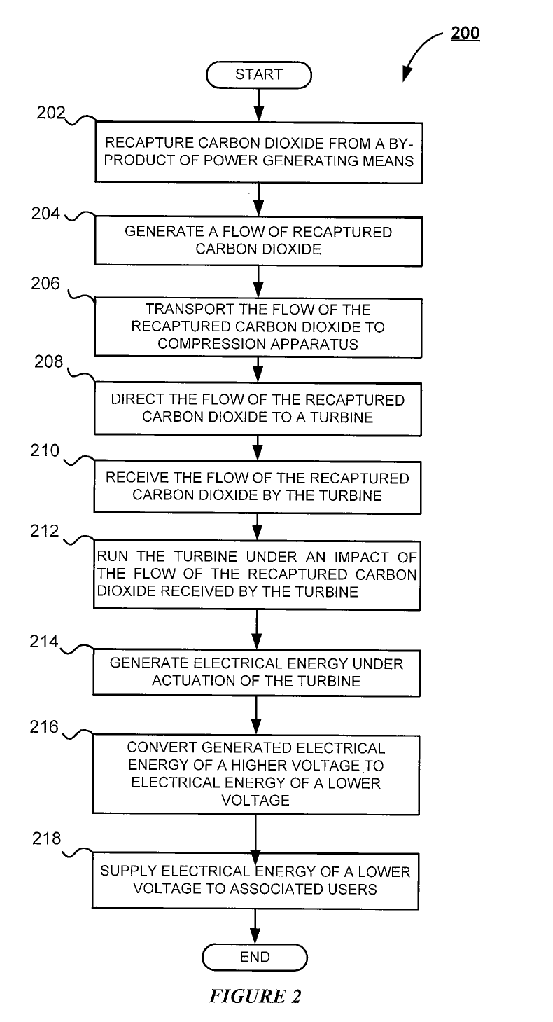

The skilled artisan will further appreciate that the subject system 100 and components described above with respect to FIG. 1, will be better understood in conjunction with the methodologies described hereinafter with respect to FIG. 2. Turning now to FIG. 2, there is shown a flowchart 200 illustrating a method for generating electrical energy in accordance with one embodiment of the subject application. Beginning at step 202 carbon dioxide is recaptured from a by-product of power generating means by the recapturing arrangement 102. A flow of recaptured carbon dioxide is then generated at step 204 by the recapturing arrangement 102. Flow then proceeds to step 206, at which step the flow of recaptured carbon dioxide via a first transporting arrangement 104 is transported to the compression apparatus 106. At step 208, the flow of recaptured carbon dioxide is converted by the compression apparatus 106 from a flow of a lower pressure to a flow of a higher pressure that is sufficient to run the turbine 108. At step 210, the flow of recaptured carbon dioxide is directed to the turbine 108 via the first transporting arrangement 104. Flow then proceeds to step 212, at which step the flow of the recaptured carbon dioxide is received by the turbine 108. At step 214, under an impact of the flow of the recaptured carbon dioxide received by the turbine 108, the turbine 118 actuates the electrical energy generator 110 enabling the electrical energy generator 110 to produce electrical energy. Generated electrical energy is then, at step 216, converted by the distribution transformer 112 to electrical energy of a lower voltage. The electrical energy of a lower voltage is supplied to associated users at step 218, via the transmission arrangement 114.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. A system for generating electrical energy comprising:
receiving means adapted for receiving a flow of recaptured carbon dioxide;
first transporting means coupled with the receiving means, adapted for transporting the flow of the recaptured carbon dioxide;
turbine means coupled with the first transporting means, adapted for receiving, via the first transporting means, the flow of the recaptured carbon dioxide; and
electrical energy generating means coupled with the turbine means;
wherein the turbine means is further adapted for running under an impact of the flow of the recaptured carbon dioxide;
wherein the turbine means is further adapted for actuating the electrical energy generating means; and
wherein the electrical energy generating means is adapted for generating electrical energy under actuation of the turbine means.

2. A system for generating electrical energy comprising of claim 1 further comprising distribution transformer means coupled with the electrical energy generating means, adapted for converting the generated electrical energy of a higher voltage to electrical energy of a lower voltage.

3. A system for generating electrical energy comprising of claim 2 further comprising transmission means coupled with the distribution transformer means;
wherein the transmission means is adapted for receiving electrical energy of a lower voltage from the distribution transformer means;
wherein the transmission means is further adapted for supplying the electrical energy of a lower voltage to associated users.

4. A system for generating electrical energy comprising of claim 1 further comprising compression means adapted for converting the flow of recaptured carbon dioxide of a lower pressure to a flow of recaptured carbon dioxide of a higher pressure;
wherein the first transporting means is coupled with the receiving means via the compression means

5. A system for generating electrical energy of claim 1 further comprising:
sequestering means; and
second transporting means coupled with the turbine means and the sequestering means;
wherein the sequestering means is adapted for receiving, via the second transporting means, a flow of the recaptured carbon dioxide from the turbine means.

6. A system for generating electrical energy comprising of claim 5 wherein the sequestering means is a hydrocarbon producing means.

7. A system for generating electrical energy comprising of claim 5 wherein the sequestering means is a sequestration site for carbon dioxide.

8. A system for generating electrical energy of claim 1 further comprising bypass means adapted for bypassing the turbine means for maintenance.

9. A method for generating electrical energy comprising the steps of:
receiving a flow of recaptured carbon dioxide;
directing the flow of the recaptured carbon dioxide to a turbine;
receiving the flow of the recaptured carbon dioxide by the turbine;
running the turbine under an impact of the flow of the recaptured carbon dioxide received by the turbine; and
generating electrical energy under actuation of the turbine.

10. A method for generating electrical energy of claim 9 further comprising the step of converting the generated electrical energy of a higher voltage to electrical energy of a lower voltage.

11. A method for generating electrical energy of claim 10 further comprising the steps of:
receiving electrical energy of a lower voltage; and
supplying the electrical energy of a lower voltage to associated users.

12. A method for generating electrical energy of claim 9 further comprising the step of converting the flow of recaptured carbon dioxide of a lower pressure to a flow of recaptured carbon dioxide of a higher pressure, wherein the step of converting is performed prior to transporting the flow of the recaptured carbon dioxide to the turbine.

13. A method for generating electrical energy of claim 9 further comprising the step of transporting the flow of the recaptured carbon dioxide from the turbine to a sequestration site

14. A method for generating electrical energy of claim 9 further comprising the step of bypassing the turbine for maintenance.
